(19) United States
(12) Patent Application Publication
(10) Pub. No.: US 2022/0252701 A1
(43) Pub. Date: Aug. 11, 2022

(54) LIDAR RECEIVING UNIT

(71) Applicant: Ibeo Automotive Systems GmbH, Hamburg (DE)

(72) Inventor: Ralf Beuschel, Wangen (DE)

(73) Assignee: Ibeo Automotive Systems GmbH, Hamburg (DE)

(21) Appl. No.: 17/621,939

(22) PCT Filed: Jun. 19, 2020
(86) PCT No.: PCT/EP2020/067139

§ 371 Date: Dec. 22, 2021

(30) Foreign Application Priority Data
Jul. 2, 2019 (DE) 10 2019 209 697.2

(51) Int. Cl. G01S 7/4863; G01S 17/10; G01S 7/481; G01S 7/4865

(52) U.S. Cl. CPC G01S 7/4863; G01S 7/4865; G01S 7/4816; G01S 17/10

(57) ABSTRACT

The present invention relates to a lidar receiving unit in a focal plane array arrangement, having: a multiplicity of sensor elements for receiving light pulses of a lidar emitting unit; and a plurality of routing channels for transporting signals of the sensor elements to an edge region (R) of the lidar receiving unit, wherein in each case a plurality of sensor elements are arranged in a macro cell, which is allocated to an emission element of the lidar emitting unit; in each case a plurality of macro cells form a macro cell cluster and in each case a plurality of macro cell clusters are arranged in a plurality of rows (Z₁, Z₂, Z₃); and the routing channels cross the plurality of rows in each case between adjacent macro cell clusters of a row and are configured for transporting the signals in a direction orthogonal to the rows. The present invention furthermore relates to a lidar measuring device for detecting an object in an environment of a vehicle.

The present invention relates to a lidar receiving unit in a focal plane array arrangement. The present invention furthermore relates to a lidar measuring device for detecting an object in an environment of a vehicle.

Modern vehicles (cars, vans, lorries, motorcycles, driverless transport systems, etc.) comprise a multiplicity of systems, which provide a driver or operator with information and/or control individual functions of the vehicle in a partially or fully automated manner. The environment of the vehicle and, if appropriate, other road users are detected by means of sensors. Based on the detected data, a model of the vehicle environment can be created and it is possible to react to changes in this vehicle environment. Due to the ongoing development in the field of autonomously and partially autonomously driving vehicles, the influence and the range of effectiveness of advanced driver assistance systems (ADAS) and autonomously operating transport systems are becoming ever greater. Due to the development of ever more precise sensors, it is possible to detect the environment and to control individual functions of the vehicle completely or partially without the intervention of the driver.

An important sensor principle for the detection of the environment in this case is lidar (light detection and ranging) technology. A lidar sensor is based on the emission of light pulses and the detection of the reflected light. A distance to the location of the reflection can be calculated by means of a time of flight measurement. A detection of a target can take place by evaluating the received reflections. With regards to the technical realization of the corresponding sensor, a distinction is made between scanning systems, which for the most part function on the basis of micromirrors, and non-scanning systems, in which a plurality of emitting and receiving elements are arranged statically side by side (in particular what is known as a focal plane array arrangement).

In this context, a method and a device for optical distance measurement are described in WO 2017/081294 A1. The use of an emission matrix for emitting measuring pulses and a reception matrix for receiving the measuring pulses is disclosed. Subsets of the emission elements of the emission matrix are activated during the emission of the measuring pulses.

One challenge in the field of non-scanning lidar measuring systems lies in the arrangement of the sensor elements in a reception array and in routing the signals of the sensor elements to the edge of the reception array. On the one hand, a highest possible density of the sensor elements of the array should be achieved. On the other hand, an efficient routing of the signals to the edge of the array for further processing should be enabled. In addition, a high resolution or a good detection should be ensured.

On this basis, it is the object of the present invention to provide an approach for the efficient reading of an array of sensor elements. In particular, an array should be realized, in which blind regions are avoided to the greatest extent possible. In addition, a high resolution should be achieved.

To achieve this object, the invention relates in a first aspect to a lidar receiving unit in a focal plane array arrangement, having:

a multiplicity of sensor elements for receiving light pulses of a lidar emitting unit; and
a plurality of routing channels for transporting signals of the sensor elements to an edge region of the lidar receiving unit, wherein
in each case a plurality of sensor elements are arranged in a macro cell, which is allocated to an emission element of the lidar emitting unit;
in each case a plurality of macro cells form a macro cell cluster and in each case a plurality of macro cell clusters are arranged in a plurality of rows; and
the routing channels cross the plurality of rows in each case between adjacent macro cell clusters of a row and are configured for transporting the signals in a direction orthogonal to the rows.

In a further aspect, the present invention relates to a lidar measuring device for detecting an object in an environment of a vehicle, having:

a lidar receiving unit according to one of the preceding claims;
a lidar emitting unit with a multiplicity of emission elements for emitting light pulses; and
a control unit for controlling the lidar emitting unit and for evaluating the signals of the sensor elements, in order to detect the object.

Preferred embodiments of the invention are described in the dependent claims. It is understood that the previously mentioned features and the features which are still to be explained in the following, can be used not only in the respectively specified combination, but also in other combinations or alone, without departing from the scope of the present invention. In particular, the lidar measuring device or the lidar emitting unit can be realized in accordance with the embodiments described in the dependent claims for the lidar receiving unit.

The sensor elements of the lidar receiving unit are configured to receive light pulses of a corresponding lidar emitting unit. A plurality of sensor elements together form a macro cell. A plurality of macro cells together form a macro cell cluster. The macro cell clusters of the lidar receiving unit are arranged in rows. In order to evaluate the signals which are created in a sensor element when receiving a light pulse, these signals must be transported away from the sensor elements via routing channels to an edge region of the lidar receiving unit. According to the invention, the routing channels are arranged orthogonally to the rows. A routing channel runs between two adjacent macro cell clusters of a row in each case. In particular, the lidar receiving unit is a microchip, on which the sensor elements are arranged, and the signals must be routed into an edge region of the chip, in which the corresponding evaluation electronics are located.

An efficient forwarding of the signals of the sensor elements to the edge region of the lidar receiving unit is achieved due to the arrangement of the routing channels according to the invention. In a row-by-row design of the lidar receiving unit and the lidar emitting unit or in the case of a row-by-row control of the lidar emitting unit, it becomes possible to achieve a routing of the signals orthogonal to the rows. As a result, a high performance can be ensured at far range. In near range, although there are gaps owing to the routing, as a result of which the resolution is reduced, the effective spatial resolution is improved, as the lidar measuring device operates with a constant angular resolution. An efficient routing is achieved. A high resolution is achievable. Due to the use of a focal plane array arrangement, a high robustness results with respect to vibrations. The service life of the lidar measuring device is improved. In addition, advantages result with regards to manufacturability. A cost-efficient realization becomes possible.

In a preferred embodiment, in each case two macro cells form a macro cell cluster. The two macro cells of the macro cell cluster are preferably arranged parallel to the rows. As a routing channel runs between two adjacent macro cell clusters of a row in each case, the two macro cells of the macro cell cluster can be read from both sides. An efficient readability results. A good contactability results due to an arrangement of the macro cells parallel to the rows.

In a preferred embodiment, the macro cell clusters of a first row are arranged offset with respect to the macro cell clusters of a second row, which is adjacent to the first row. Due to the offset arrangement (interlace structure), vertical blind regions (orthogonal to the rows), in which no detections can take place, are avoided. An improved detection of objects results.

In a preferred embodiment, the routing channels run parallel to the rows in channel sections between the rows. The channels can run parallel to the rows at least in certain sections. Nevertheless, the signals are transported out of the array orthogonally to the rows. The channel sections running parallel to the rows are advantageous in this case in particular if the macro cell clusters of two adjacent rows are arranged offset with respect to one another.

In a preferred embodiment, a distance between adjacent macro cell clusters of a row is greater than a distance between adjacent macro cell clusters in adjacent rows. Additionally or alternatively, preprocessing elements are in each case arranged between adjacent rows for reading the sensor elements. The preprocessing elements preferably comprise a transistor in this case. The distances are preferably chosen such that a highest possible density of the sensor elements of the lidar receiving unit results. As many sensor elements as possible should be arranged on a chip. The routing takes place between adjacent macro cell clusters of a row in each case. Preprocessing elements are arranged between the rows, which for the most part require comparatively less space.

In a preferred embodiment, a whole number multiple of a diameter of the sensor elements is different from a distance between midpoints of the allocated emission elements of the lidar emitting unit. As, in each case, a plurality of sensor elements receive a light pulse of an emission element, poorer detections may result due to alignment errors. A balancing out or averaging of these errors may take place by means of a corresponding choice of the diameter of the sensor elements or the distance between midpoints of the allocated emission elements. Thus, a levelling of the errors results, so to say, in that at least one macro cell does not match completely, in terms of its imaging position on the reception array, with the allocated emission element. An improved detection of objects results in the sense of an improved usability of the sensor data.

In a preferred embodiment, sensor elements with reduced sensitivity are arranged between macro cells of a macro cell cluster. In particular, emission elements can be used, which have a metallization on an opening and thus receive fewer photons. This results in an improved delimitability between adjacent macro cells of a macro cell cluster. An improved detection of objects is achieved.

In a preferred embodiment, the lidar receiving unit comprises evaluation electronics for row-by-row reading of the sensor elements. The evaluation electronics are preferably likewise arranged on the chip. The signals of the sensor elements are evaluated in order to enable an object detection.

In a preferred embodiment, a macro cell cluster comprises between 14 and 34 sensor elements.

A focal plane array arrangement is understood to mean a configuration of the sensor elements (or the emission elements) substantially in one plane. A lidar receiving unit is a microchip with the corresponding sensor elements in particular. A lidar emitting unit is likewise a microchip with the corresponding emission elements in particular. The receiving unit and emitting unit may also be arranged together on one microchip. The sensor elements are arranged on a chip in matrix form. The sensor elements are distributed over a surface of the chip of the lidar receiving unit. A light pulse of a lidar emitting unit is in particular understood to mean a pulse of laser light. An environment of a vehicle in particular comprises a region visible from the vehicle in the vicinity of the vehicle.

In the following, the invention is described and explained in more detail on the basis of a few selected exemplary embodiments in connection with the attached drawings. In the figures:

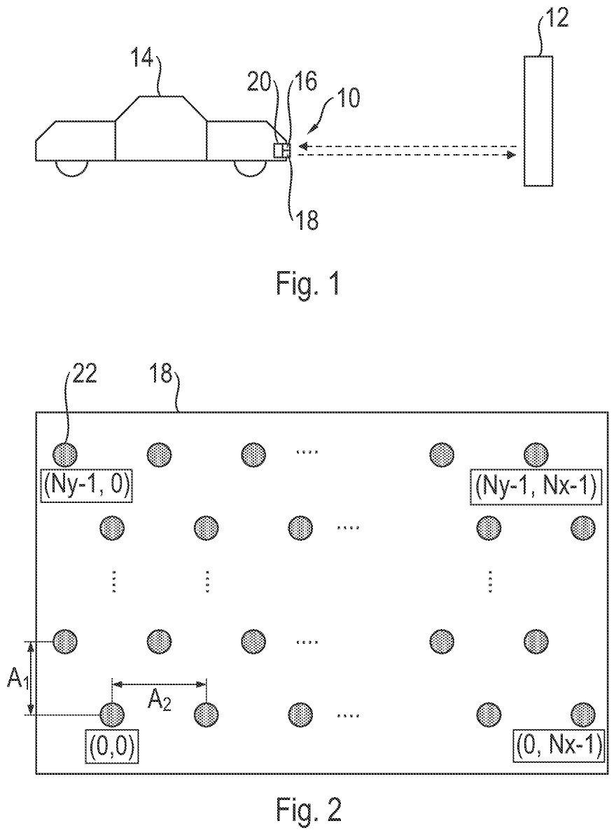

FIG. 1 shows a schematic illustration of a lidar measuring device according to the invention for detecting an object in an environment of a vehicle;

FIG. 2 shows a schematic illustration of a lidar emitting unit for emitting light pulses;

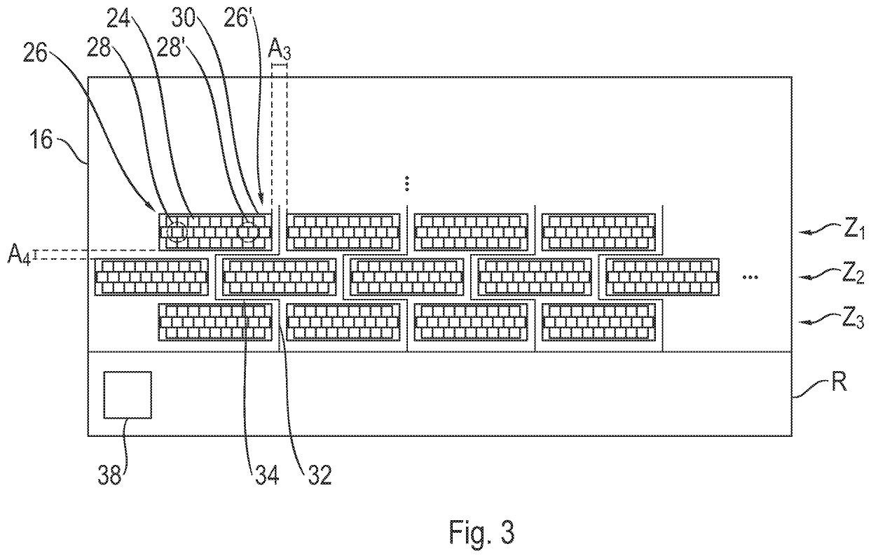

FIG. 3 shows a schematic illustration of a lidar receiving unit according to the invention; and

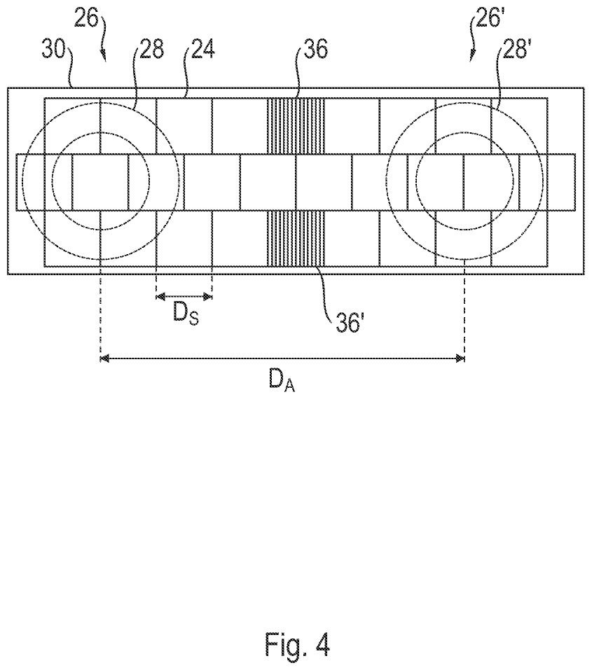

FIG. 4 shows a schematic illustration of a macro cell of a lidar receiving unit according to the invention.

A lidar measuring device 10 according to the invention for detecting an object 12 in an environment of a vehicle 14 is illustrated schematically in FIG. 1. In the illustrated exemplary embodiment, the lidar measuring device 10 is integrated into the vehicle 14. The object 12 in the environment of the vehicle 14 may for example be another vehicle or else a static object (traffic sign, house, tree, etc.) or a different road user (pedestrian, cyclist, etc.). The lidar measuring device 10 is preferably mounted in the region of a bumper of the vehicle 14, and may in particular evaluate the environment of the vehicle 14 in front of the vehicle. For example, the lidar measuring device 10 may be integrated into the front bumper.

The lidar measuring device 10 according to the invention comprises a lidar receiving unit 16 and a lidar emitting unit 18. Furthermore, the lidar measuring device 10 comprises a control unit 20 for controlling the lidar emitting unit 18 and for evaluating the signals of the sensor elements of the lidar receiving unit 16.

Preferably, both the lidar receiving unit 16 and the lidar emitting unit 18 are constructed in a focal plane array configuration. The elements of the respective device are essentially arranged in one plane on a corresponding chip. The chip of the lidar receiving unit or the lidar emitting unit is arranged at a focal point of a corresponding optical element (emitting optical element or receiving optical element). In particular, sensor elements of the lidar receiving unit or emission elements of the lidar emitting unit 18 are arranged at the focal point of the respective receiving or emitting optical element. This optical element may for example be formed by an optical lens system.

The sensor elements of the lidar receiving unit 16 are preferably constructed as a SPAD (single photon avalanche diode). The lidar emitting unit 18 comprises a plurality of emission elements for emitting laser light or laser pulses. The emission elements are preferably constructed as VCSELs (vertical cavity surface emitting lasers). The emission elements of the lidar emitting unit 18 are distributed over a surface of an emission chip. The sensor elements of the lidar receiving unit 16 are distributed over a surface of the reception chip.

An emitting optical element is assigned to the emission chip, a receiving optical element is assigned to the reception chip. The optical element images a light arriving from a spatial region onto the respective chip. The spatial region corresponds to the visual range of the lidar measuring device 10, which is investigated or scanned for objects 12. The spatial region of the lidar receiving unit 16 or the lidar emitting unit 18 is substantially identical. The emitting optical element forms an emission element at a spatial angle which represents a part region of the spatial region. The emission element correspondingly emits laser light into this spatial angle. The emission elements together cover the entire spatial region. The receiving optical element maps a sensor element onto a spatial angle which constitutes a part region of the spatial region. The number of all sensor elements covers the entire spatial region. Emission elements and sensor elements which view the same spatial angle image to one another and are correspondingly assigned or allocated to one another. Normally, laser light of an emission element images onto the associated sensor element. A plurality of sensor elements are beneficially arranged inside the spatial angle of an emission element.

The lidar measuring device 10 carries out a measuring procedure for determining or detecting objects 12 inside the spatial region. A measuring procedure of this type comprises one or more measuring cycles, depending on the structural design of the measuring system and the electronics thereof. Preferably a TCSPC method (time correlated single photon counting method) is used in the control unit 20 here. Here, individual arriving photons are detected, particularly by a SPAD, and the time of triggering of the sensor element (detection time) is stored in a storage element. The detection time has a relationship to a reference time, at which the laser light is emitted. The time of flight of the laser light can be determined from the difference, from which the distance of the object 12 can be determined.

A sensor element of the lidar receiving unit 16 can be triggered on the one hand by the laser light and on the other hand by ambient radiation. Laser light always arrives at the same time for a certain distance of the object 12, whereas the ambient radiation has the same likelihood of triggering a sensor element at any time. Upon carrying out a measurement multiple times, particularly a plurality of measuring cycles, the triggerings of the sensor element at the detection time, which corresponds to the time of flight of the laser light with respect to the distance of the object, add up. By contrast, the triggerings due to the ambient radiation are distributed evenly over the measurement duration of a measuring cycle. A measurement corresponds to the emission and subsequent detection of the laser light. The data of the individual measuring cycles of a measuring procedure stored in the storage element enable an evaluation of the detection times determined multiple times, in order to reach a conclusion about the distance of the object 12.

A sensor element is beneficially connected to a TDC (time to digital converter). The TDC stores the time of triggering of the sensor element in the storage element. A storage element of this type may for example be constructed as a short-term storage device or as a long-term storage device. The TDC fills a storage device with the times, at which the sensor elements detect an arriving photon, for a measuring procedure. This can be illustrated graphically by a histogram, which is based on the data of the storage element. In a histogram, the duration of a measuring cycle is divided into very short time sections (what are known as bins). If a sensor element is triggered, then the TDC increases the value of a bin by 1. The bin is filled, which corresponds to the time of flight of the laser pulse, that is to say the difference between detection time and reference time.

The structure of the lidar emitting unit 18 is illustrated schematically in FIG. 2. The chip comprises a plurality of emission elements 22, which are arranged in an array (matrix). For example, several thousand emission elements may be used. The emission elements 22 are controlled row-by-row. To give a better overview, only one emission element 22 is provided with a reference number.

In the exemplary embodiment illustrated, the rows 0 . . . ny−1 in each case correspond to a multiplicity of emission elements 0 . . . nx−1. For example, 100 rows (ny=100) and 128 emission elements per row (nx=128) may be provided. The row distance A1 between the rows may lie in the range of a few micrometres, for example 40 μm. The element distance A2 between emission elements 22 in the same row may lie in a similar order of magnitude.

A lidar receiving unit 16 according to the invention is illustrated schematically in FIG. 3. The lidar receiving unit 16 comprises a multiplicity of sensor elements 24. The sensor elements are in each case arranged in macro cells 26, 26′, wherein a macro cell 26, 26′ comprises those sensor elements 24 which are together allocated to an individual emission element 22 of the lidar emitting unit. Two macro cells 26, 26′ are arranged in a macro cell cluster 30 in each case. The plurality of macro cell clusters 30 are arranged in a plurality of rows Z₁, Z₂, Z₃. Routing channels 32 are arranged between two adjacent macro cell clusters 30 in each case, which routing channels cross the rows Z₁, Z₂, Z₃ and are constructed to transport the signals of the sensor elements 24 to an edge region R of the lidar receiving unit 16.

Two exemplary spot positions 28, 28′ are furthermore marked schematically in the illustration of FIG. 3, which correspond to the positions of allocated emission elements of the lidar emitting unit in the array of the lidar receiving unit 16.

It is understood that only a detail of the structure of the chip of the lidar receiving unit 16 is illustrated in FIG. 3, in order to visualize the arrangement of the sensor elements 24, routing channels 32, macro cells 26 and macro cell clusters 30. The chip extends further upwards and to the side in the illustration. Preferably, the number of macro cells corresponds to the number of emission elements of the lidar emitting unit 18. For a better overview, in each case not all sensor elements 24 or macro cells 26, 26′ and macro cell clusters 30 are provided with reference numbers.

As illustrated, the routing channels 32 in the illustrated exemplary embodiment in each case run between adjacent macro cell clusters 30 and transport the signals in a direction orthogonal to the course of the rows Z₁, Z₂, Z₃. In the illustrated exemplary embodiment, the routing channels have channel sections 34 in this case, which run in a region between the rows, parallel to the rows. As a result, it becomes possible that the macro cell clusters 30 of a first row are arranged offset with respect to the macro cell clusters 30 of a second row, which is adjacent to the first row. This has the effect that in the vertical direction, no vertical blind regions are created. In this respect, the macro cell clusters 30 are arranged in an interlace structure. The sensor elements or spots of the adjacent row are arranged in the gaps of a row.

As furthermore shown in the illustrated exemplary embodiment, a distance A3 between adjacent macro cell clusters 30 of a row is greater than a distance A4 between adjacent macro cell clusters 30 in adjacent (neighbouring) rows. The routing channels 32 run within the distance A3 or between the macro cell clusters. In addition, preprocessing elements, preferably transistors, may be arranged between the rows Z₁, Z₂, Z₃.

Evaluation electronics 38 may be provided in the edge region of the chip of the lidar receiving unit 16, which are designed to read the sensor elements 24 row-by-row or to further process the signals of the sensor elements.

An individual macro cell cluster 30 is illustrated schematically in FIG. 4. In the illustrated exemplary embodiment, the macro cell cluster 30 in total comprises 28 sensor elements 24 and two macro cells 26, 26′ respectively. In the illustrated exemplary embodiment, two sensor elements with reduced sensitivity 36, 36′ are arranged between the two macro cells 26, 26′ or at the edge of one or both macro cells 26, 26′. For example, the sensor elements with reduced sensitivity 36, 36′ may be sensor elements with a metallization on the opening, so that fewer photons can be received. The sensor elements with reduced sensitivity 36, 36′ may also be termed aperture SPADs. It is understood that a different number of sensor elements with reduced sensitivity may also be used.

In the illustration, two exemplary spot positions 28, 28′ are marked, which represent positions of emission elements, which are allocated to the macro cells 26, 26′. As a whole number multiple of a diameter D_{S} of the sensor elements is different from a distance D_{A} between midpoints of allocated emission elements of the lidar emitting unit, which are located at the positions P1 and P2, a balancing out of alignment errors is achieved. The highest photon density is in each case received at the centre of the spot positions 28, 28′ of the emission elements on the macro cell cluster. In other words, the reception elements at the centres of the spot positions 28, 28′ receive the highest photon density in each case. As the spot positions 28, 28′ cannot be aligned exactly with respect to the array of the lidar receiving unit, a distance D_{A}, which corresponds to a whole number multiple of the distance D_{S}, would lead to both spot positions 28, 28′ being hit well or poorly. Due to the choice according to the invention of the distances D_{S} and D_{A}, this is avoided and a levelling of the errors is achieved in the event of imprecise alignment.

The invention was described and explained comprehensively on the basis of the drawings and the description. The description and explanation are to be understood as an example and non-limiting. The invention is not limited to the embodiments disclosed. Other embodiments or variations will arise for the person skilled in the art when using the present invention and during a precise analysis of the drawings, the disclosure and the following patent claims.

In the patent claims, the words “comprise” and “with” do not exclude the presence of further elements or steps. The indefinite article “a” or “an” does not exclude the presence of a plurality. An individual element or an individual unit may execute the functions of a plurality of the units mentioned in the patent claims. An element, a unit, an interface, a device and a system may be implemented partially or completely in hard- and/or software. The mere mention of a few measures in several dependent patent claims is not to be understood to mean that a combination of these measures cannot likewise be used advantageously. Reference numbers in the patent claims are not to be understood as limiting.

### REFERENCE NUMBERS

10 Lidar measuring device
12 Object
14 Vehicle
16 Lidar receiving unit
18 Lidar emitting unit
20 Control unit
22 Emission element
24 Sensor element
26 Macro cell
28 Spot position
30 Macro cell cluster
32 Routing channel
34 Channel section
36, 36′ Sensor element with reduced sensitivity

1. A lidar receiving unit in a focal plane array arrangement, having:
a multiplicity of sensor elements for receiving light pulses of a lidar emitting unit; and
a plurality of routing channels for transporting signals of the sensor elements to an edge region of the lidar receiving unit, wherein
in each case a plurality of sensor elements are arranged in a macro cell, which is allocated to an emission element of the lidar emitting unit;
in each case a plurality of macro cells form a macro cell cluster W) and in each case a plurality of macro cell clusters are arranged in a plurality of rows (Z₁, Z₂, Z₃); and
the routing channels cross the plurality of rows in each case between adjacent macro cell clusters of a row and are configured for transporting the signals in a direction orthogonal to the rows.

2. The lidar receiving unit according to claim 1,
wherein
in each case two macro cells form a macro cell cluster; and
the two macro cells of the macro cell cluster are preferably arranged parallel to the rows (Z₁, Z₂, Z₃).

3. The lidar receiving unit according to claim 1, wherein the macro cell clusters of a first row (Z₁, Z₂, Z₃) are arranged offset with respect to the macro cell clusters of a second row, which is adjacent to the first row.

4. The lidar receiving unit according to claim 1, wherein the routing channels run in channel sections between the rows (Z₁, Z₂, Z₃), parallel to the rows.

5. The lidar-receiving unit according to claim 1, wherein
a distance (A₃) between adjacent macro cell clusters of a row (Z₁, Z₂, Z₃) is greater than a distance (A₄) between adjacent macro cell clusters in adjacent rows; and/or
in each case preprocessing elements for reading the sensor elements are arranged between adjacent rows (Z₁, Z₂, Z₃), wherein the preprocessing elements preferably comprise a transistor.

6. The lidar-receiving unit according to claim 1, wherein a whole number multiple of a diameter (D_{S}) of the sensor elements is different from a distance (D_{A}) between midpoints of the allocated emission elements of the lidar emitting unit.

7. The lidar-receiving unit according to claim 1, wherein sensor elements with reduced sensitivity are arranged between macro cells of a macro cell cluster.

8. The lidar-receiving unit according to claim 1, having evaluation electronics for row-by-row reading of the sensor elements.

9. The lidar-receiving unit according to claim 1, wherein a macro cell cluster comprises between 14 and 34 sensor elements.

10. A lidar measuring device for detecting an object in an environment of a vehicle, having:
a lidar receiving unit according to one of the preceding claims;
a lidar emitting unit with a multiplicity of emission elements for emitting light pulses; and
a control unit for controlling the lidar emitting unit and for evaluating the signals of the sensor elements, in order to detect the object.
